(19) United States
(12) Patent Application Publication
(10) Pub. No.: US 2015/0144615 A1
(43) Pub. Date: May 28, 2015

(54) BRAZING METHOD AND DEVICE FOR GLASS KOVAR COMBINATION AND OXYGEN-FREE COPPER

(71) Applicant: WUXI UNICOMP TECHNOLOGY CO., LTD., Wuxi (CN)

(72) Inventors: JUN LIU, Wuxi (CN); Aijun WU, Wuxi (CN); Liucheng WANG, Wuxi (CN); Yulin LI, Wuxi (CN)

(73) Assignee: WUXI UNICOMP TECHNOLOGY CO., LTD., Wuxi (CN)

(21) Appl. No.: 14/166,646

(22) Filed: Jan. 28, 2014

(30) Foreign Application Priority Data
Nov. 26, 2013 (CN) 20131064114.2

(51) Int. Cl. B23K 3/047; B23K 1/002

(52) U.S. Cl. CPC B23K 3/0475; B23K 1/002
USPC 219/615

(57) ABSTRACT

The invention discloses a brazing method for a glass Kovar combination and an oxygen-free copper, wherein the glass Kovar combination, the silver-based solder and the oxygen-free copper are placed within a quartz room with the pressure of 3.0×10⁻⁵˜7.0×10⁻⁵ Pa. The quartz room is heated by the coils of the high-frequency induction power; and the quartz room stops being heated quickly until reaching the melting temperature of the silver-based solder and then being cooled. The invention further discloses a corresponding brazing device, which simplifies the processing technology in the electronic vacuum industry, reduces the rejection rate greatly, has significant industrial economic value and is the important method of the energy conservation and environment protection. It enables the brazing process time to be short; the energy consumption to be reduced; the whole brazing process to be visible; the temperature to be monitored; and the manufacturing cost to be greatly reduced.

The present invention claims the priority benefit of Chinese Application No. 201310604114.2, filed Nov. 26, 2013, which is hereby incorporated by reference.

### FIELD OF THE INVENTION

The present invention belongs to the technical field of metal processing, especially a brazing method and a brazing device for glass Kovar combination (glass and iron-nickel-cobalt alloys) and oxygen-free copper.

### DESCRIPTION OF THE PRIOR ART

The traditional brazing method for glass Kovar combination and oxygen-free copper is the method of heating electric stove wires. If antioxidant brazing is needed, the brazing is carried out in a hydrogen frame oven; and the method brazes metals only rather than glass Kovar combination and metals, because the softening temperature of the glass is 650° C. and the melting temperature of the silver-based solder is 850° C. In other words, the glass Kovar combination has been destroyed in the hydrogen frame oven while the silver-based solder is not melt.

### SUMMARY OF THE INVENTION

In order to overcome the shortcomings of the existing technology, the present invention discloses a brazing method for a glass Kovar combination and an oxygen-free copper, which improves the traditional brazing method so that it is possible to braze metals with vitreous bodies.

In order to achieve the above invention objects, the present invention provides a technical solution as follows: a brazing method for a glass Kovar combination and an oxygen-free copper; the glass Kovar combination, the silver-based solder and the oxygen-free copper are placed within a quartz room, with a pressure of 3.0×10⁻⁵˜7.0×10⁻⁵ Pa; the quartz room is heated by the coils with a high-frequency induction power; and the quartz room stops being heated quickly until reaching the melting temperature of the silver-based solder and then begins being cooled.

Furthermore, the pressure in the quartz room is 5.0×10⁻⁵ Pa.

Furthermore, the melting temperature of the silver-based solder is obtained in such a method that the surface temperature of the oxygen-free copper is measured by a high-speed digital infrared thermometer.

The present invention further discloses a brazing device for a glass Kovar combination and an oxygen-free copper, comprising a quartz vacuum room, a vacuum exhaust station, a high-frequency induction power, a high-speed digital infrared thermometer, an insulator, a heating element, a heat conduction ring and an oxygen-free copper main body, wherein the quartz vacuum room is communicated with the vacuum exhaust station; the high-frequency induction power and the high-speed digital infrared thermometer are installed on the vacuum exhaust station; the insulator is placed within the quartz vacuum room; the heating element is put on the insulator; the heat conduction ring is arranged on the heating element; and the brazing main body is placed within the heat conduction ring.

Furthermore, the pressure in the quartz vacuum room is 3.0×10⁻⁵˜7.0×10⁻⁵ Pa.

Furthermore, the pressure in the quartz vacuum room is 5.0×10⁻⁵ Pa.

Furthermore, the measuring error of the high-speed digital infrared thermometer is less than 5° C.

Compared with the prior art, the present invention has the advantages of simplifying the processing technology in the electronic vacuum industry, significantly reducing the defects rate, having significant industrial economic value and being the important method of energy conservation and environment protection. It reduces the brazing process time and the energy consumption. The whole brazing process is visible. The temperature can be monitored. The manufacturing cost is greatly reduced.

### BRIEF DESCRIPTION OF THE DRAWING

FIG. 1 is the structural diagrammatic view of the device of the present invention.

FIG. 2 is the partially enlarged diagrammatic view of the device of the preset invention.

In the figures:

1. a quartz vacuum room; 2. a high-frequency induction power coil; 3. a vacuum exhaust station; 4. a brazing body; 5. a heating element; 6. an insulator, 7. a high-speed digital infrared thermometer; and 8. a heat conduction ring.

### DETAILED DESCRIPTION OF THE PREFERRED EMBODIMENT

The present invention is described in details by combining with the attached drawings; the description is demonstration and explanation rather than having any limitation on the protection scope of the invention.

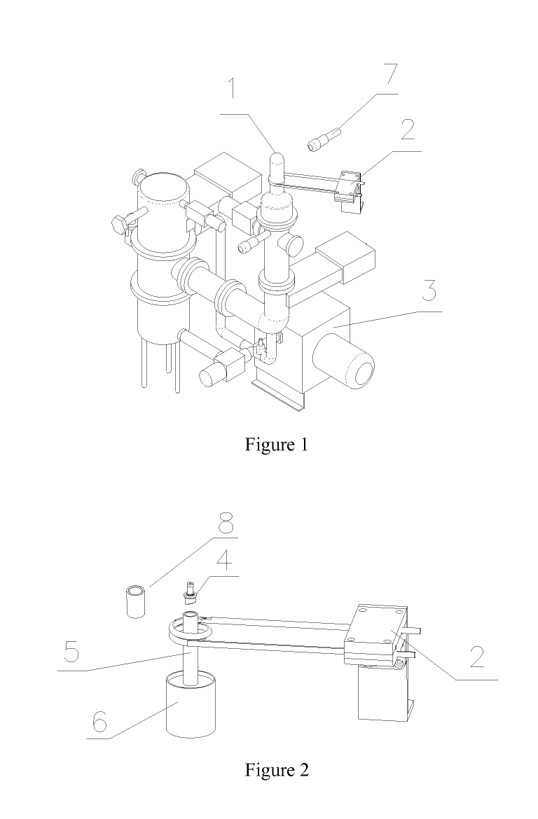

FIG. 1 and FIG. 2 show a brazing device for a glass Kovar combination and an oxygen-free copper, comprising a quartz vacuum room 1, a vacuum exhaust station 3, a high-frequency induction power 2, a compound high-speed digital infrared thermometer 7, an insulator 6, a heating element 5 and a heat conduction ring 8, whereby achieving the purpose of brazing the glass Kovar combination and the oxygen-free copper with the silver-based solder.

The insulator 6 is placed within the quartz vacuum room 1; the heating element 5 is put on the insulator 6; the heat conduction ring 8 is arranged on the heating element 5; and the brazing main body 4, such as oxygen-free copper, is placed within the heat conduction ring 8. The silver-based solder and the glass Kovar combination are placed on the brazing main body 4 according to the requirements. The quartz vacuum room 1 is sealed and the vacuum exhaust station 3 is started so that the barometric pressure in the quartz vacuum room can reach 3.0×10⁻⁵˜7.0×10⁻⁵ Pa, preferably 5.0×10⁻⁵ Pa. The coils of the high-frequency induction power 2 are sleeved outside the quartz vacuum room 1 and kept the same height as the heating element 5 in the quartz vacuum room 1. The high-frequency induction power 2 is started; the surface temperature of the brazing main body 4 is measured by the compound high-speed digital infrared thermometer 7; after the surface temperature reaches the melting temperature of the silver based solder, the high-frequency power is quickly turned off to prevent the glass being softened; and after cooling, the silver-based solder is quickly taken out and stored in the vacuum case.

The brazing main body and the glass Kovar combination can be processed to various types and shapes by employing the method and device in the invention. The high-frequency induction power heats the heating element and melts the solder by the heat conduction to complete the welding thus preventing the glass of the glass Kovar combination being softened due to heat. The sealing flange of the quartz clock cover of the quartz vacuum room 1 is cooled by the circulating water. The brazing main body 4 in the quartz vacuum room 1 is subjected to the precise temperature test of which the error is less than 5° C. by the compound high-speed digital infrared thermometer 7.

The present invention has the following advantages. It is possible to braze metals with vitreous bodies. The brazing process is shorten. The energy consumption is reduced. The whole brazing process is visible. The temperature is monitored. The invention changes the brazing method of the traditional process so that it is possible to braze metals with vitreous bodies. The present invention simplifies the processing technology in the electronic vacuum industry, greatly reduces the defect rate, has significant industrial economic value and greatly reduces the manufacturing cost.

1. A brazing method for a glass Kovar combination and an oxygen-free copper, wherein the glass Kovar combination, a silver-based solder and the oxygen-free copper are placed within a quartz room with the pressure of 3.0×10⁻⁵-7.0×10⁻⁵ Pa; the quartz room is heated by coils with high-frequency induction power; and heating of the quartz room is immediately stopped when until melting temperature of the silver-based solder is reached and then the quartz room is cooled.

2. The brazing method for glass Kovar combination and oxygen-free copper according to claim 1, wherein the pressure in the quartz room is 5.0×10⁻⁵ Pa.

3. The brazing method for a glass Kovar combination and an oxygen-free copper according to claim 1, wherein the melting temperature of the silver-based solder is detected by measuring surface temperature of the oxygen-free copper through a high-speed digital infrared thermometer.

4. A brazing device for a glass Kovar combination and an oxygen-free copper, comprising a quartz vacuum room, a vacuum exhaust station, a high-frequency induction power, a high-speed digital infrared thermometer, an insulator, a heating element, a heat conduction ring and an oxygen-free copper main body, wherein the quartz vacuum room is communicated with the vacuum exhaust station; the high-frequency induction power and the high-speed digital infrared thermometer are installed on the vacuum exhaust station; the insulator is placed within the quartz vacuum room; the heating element is put on the insulator; the heat conduction ring is arranged on the heating element; and the brazing main body is placed within the heat conduction ring.

5. The brazing device according to claim 4, wherein the pressure in the quartz vacuum room is 3.0×10⁻⁵-7.0×10⁻⁵ Pa.

6. The brazing device according to claim 5, wherein the pressure in the quartz vacuum room is 5.0×10⁻⁵ Pa.

7. The brazing device according to claim 4, wherein measuring error of the high-speed digital infrared thermometer is less than 5° C.
